(19) United States
(12) Patent Application Publication
(10) Pub. No.: US 2026/0037644 A1
(43) Pub. Date: Feb. 5, 2026

(54) CUSTOMIZED INSTRUCTION-SET CRYPTOGRAPHY ENGINE

(71) Applicant: Microsoft Technology Licensing, LLC, Redmond, WA (US)

(72) Inventors: Mojtaba BISHEH NIASAR, Durham, NH (US); Bharat S. PILLILLI, El Dorado Hills, CA (US); Michael Jeffrey NORRIS, Folsom, CA (US)

(21) Appl. No.: 18/792,212

(22) Filed: Aug. 1, 2024

(51) Int. Cl. G06F 21/60; G06F 9/30

(52) U.S. Cl. CPC G06F 21/602; G06F 9/30156

(57) ABSTRACT

A lattice-based cryptography engine includes an interface configured to receive a lattice-based cryptographic operation request including corresponding operands. A register map is configured to store the operands and response to the request. A controller is coupled to receive the operands and output a sequence of instructions responsive to the request. A plurality of hardware units is coupled to receive and execute the instructions to generate the response. Each instruction is designated for one of the plurality of hardware units. A memory is coupled to the hardware units.

### BACKGROUND

The advent of quantum computers poses a serious challenge to the security of the existing public-key cryptosystems, as the existing public-key cryptosystems can potentially be broken based on Shor's algorithm. Lattice-based cryptosystems are among the most promising post quantum computing (PQC) algorithms that are believed to be hard to crack for both classical and quantum computers.

Security requirements for cryptosystem engines are evolving. It is difficult to design such engines that have high performance and are flexible and efficient in the face of the evolving requirements.

### SUMMARY

A lattice-based cryptography engine includes an interface configured to receive a lattice-based cryptographic operation request including corresponding operands. A register map is configured to store the operands and response to the request. A controller is coupled to receive the operands and output a sequence of instructions responsive to the request. A plurality of hardware units is coupled to receive and execute the instructions to generate the response. Each instruction is designated for one of the plurality of hardware units. A memory is coupled to the hardware units.

### BRIEF DESCRIPTION OF THE DRAWINGS

FIG. 1 is a high-level block diagram of a system for performing cryptographic functions and operations according to an example embodiment.

FIG. 2 is a detailed block diagram of lattice-based cryptographic engine according to an example embodiment.

FIG. 3 is a block diagram illustrating a hardware controller and selected hardware units according to an example embodiment.

FIG. 4 is a flowchart illustrating a method of performing lattice-based cryptographic operations via a hardware engine that includes programmable instructions sets corresponding to the operations according to an example embodiment.

FIG. 5 is a flowchart illustrating a method of sequencing instructions according to an example embodiment.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

In the realm of hardware post quantum computing (PQC) cryptography implementations, two primary approaches stand out: a full hardware (HW) methodology and a HW/SW co-design. While the former offers superior performance, it comes at the expense of longer design cycles, reduced flexibility, and the need for customized data paths tailored to specific protocol-level operations. On the other hand, using an instruction-set processor yields a smaller, simpler, and more controllable design, albeit with slower execution.

A customized instruction-set emerges as an attractive compromise. By fine-tuning hardware acceleration, efficiency is achieved without excessive logic overhead. However, implementing a full HW architecture often involves cascading computation units in a rigid data flow, resulting in significant latency.

An improved post-quantum cryptography (PQC) engine performs PQC cryptographic tasks. The engine features a hardware controller with a tailored instruction set enabling the engine to adapt to evolving security requirements. The engine may be implemented as an IP (intellectual property) core via a field programmable gate array (FPGA) and application specific integrated circuit (ASIC) platforms with a pipelined architecture. By forming the engine in such platforms using semiconductor processing techniques, speed of performing operations is greatly enhanced over software based implementations.

Instructions are included for cryptographic related units for computing cryptographic functions such as SHAKE256, number theoretic transform (NTT), and inverse number theoretic transform (INTT). The hardware controller is a high-level controller that includes an instruction sequencer. A modular design of the engine allows dynamic adaptation to new instructions, ensuring flexibility for NIST (National Institute of Science and Technology) PQC encryption standards updates.

The improved engine utilizes hardware implemented computation blocks while maintaining flexibility and adaptability for future extensions. The adaptability proves very useful in a rapidly evolving field like post-quantum cryptography (PQC), even amidst existing HW architectures.

The improved cryptography engine with a customized instruction-set provides efficient cryptographic operations while allowing flexibility for changes in NIST ML-DSA (Module Lattice Digital Signature Algorithm) standards and varying security levels.

The following paragraphs describe the architecture, instruction set design, sequencer functionality, and hardware for the improved PQC engine.

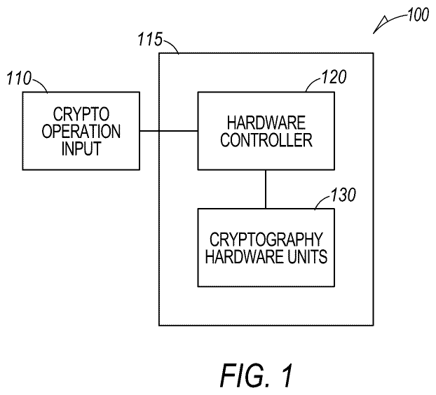

FIG. 1 is a high-level block diagram of a system 100 for performing cryptographic functions and operations. An operation input 110 represents applications, user interfaces, or other entities operating on a host processor that can request cryptographic functions and operations. An improved cryptographic engine 115 represents a specialized hardware module designed exclusively for PQC cryptographic tasks. A hardware controller 120 receives requests for cryptographic functions and operations and provides strings of commands to one or more cryptography hardware units 130.

Engine 115 efficiently executes cryptographic operations while accommodating evolving security requirements. Engine 115 may be implemented as an Intellectual Property (IP) core within an FPGA or ASIC, featuring a pipelined design for streamlined execution and interfaces for seamless communication with operation input 110.

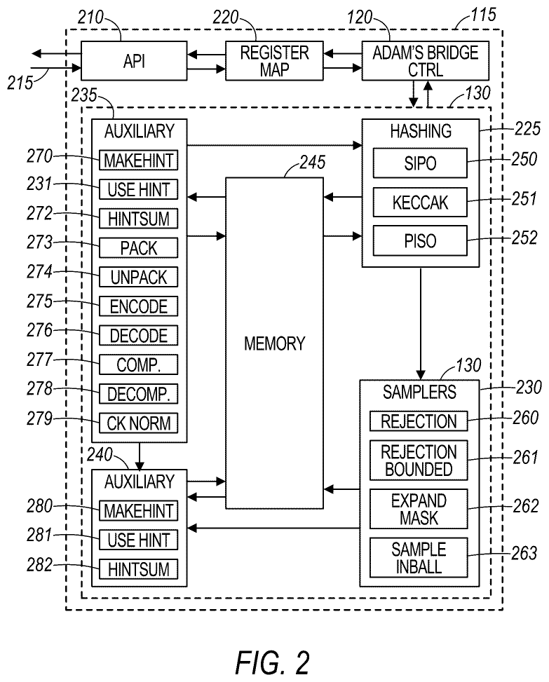

FIG. 2 is a detailed block diagram of lattice-based cryptographic engine 115. Engine 115 includes an application programming input, API 210, a register map 220, and controller 120, which may be an Adam's Bridge controller. API 210 receives requests from operation input 110 and stores various opcodes and operands in a register map 220.

Controller 120 reads the opcodes and operands from register map 220 and provides sequences of instructions to multiple hardware units 130. Hardware units 130 include a hashing unit 225, samplers 230, auxiliary units 235, arithmetic units 240 and memory 245. The units may interface directly with memory 245 or in some cases interface directly with other units to pass data.

Hashing unit 225 includes a serial-in parallel-out memory 250, a Keccak random number generator 251, and a parallel-in serial-out memory 252 for providing polynomial coefficients to other units, such as units in samplers 230. Samplers 230 include a Rejection sampler unit 260, Rejection Bounded sampler unit 261, Expand Mask 262, and a Sample InBall unit 263.

Auxiliary unit 235 includes several hardware units, such as MakeHint 270, UseHint 271, HintSum 272, Pack 273, Unpack 274, Encode 275, Decode 276, Comp 277, Decomp 278, and Ck Norm 279. Arithmetic unit 240 includes NTT 280, point-wise multilplication (PWM) 281, and Add/Sub 282.

Specific sets of instructions are defined for utilizing various submodules to perform SHAKE256, SHAKE128, Number-Theoretic Transform (NTT), Inverse NTT (INTT), and Polynomial Weighted Multiplication (PWM). Each instruction is associated with an opcode and one or more operands. By customizing these instructions, the engine's behavior may be tailored to different security levels.

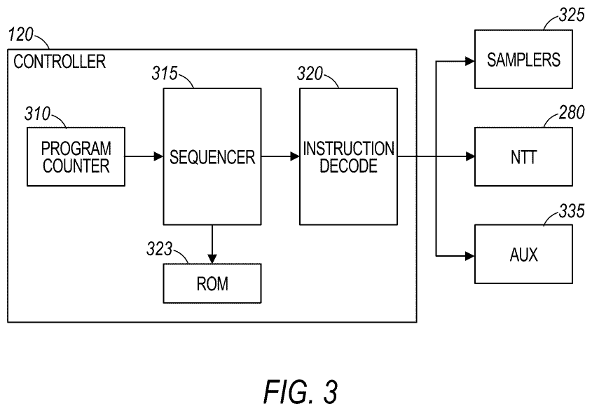

FIG. 3 is a block diagram illustrating controller 120 and selected hardware units, samplers 325, NTT 280, and auxiliary 335. Controller 120 includes a program counter 310, sequencer 315, and instruction decode 320. To execute instructions in accordance with received requests, sequencer 315 orchestrates a precise sequence of operations. Sequencer 315 provides memory 245 addresses for each operation. Additionally, the sequencer 315 handles instruction fetching and operand retrieval from an included programmable ROM 323. Instructions are decoded by instruction decode 320 and provided to the appropriate units for execution. Controller 120 stores results in register map 220, which are returned by API 210 to input 110 responsive to the request.

The program counter 310 drives the current program count to the sequencer 315. The sequencer 315 contains the sequence of instructions in ROM 323 for each algorithm and drives the relevant instruction to the instruction decode 320.

The decoded instruction drives control paths to the samplers, NTT or Auxiliary functions.

By leveraging a modular design, the engine 115 can dynamically accommodate new instructions by simply loading the instructions into the ROM 323. Such accommodation is helpful in a field like PQC where standards evolve rapidly. When NIST introduces updates or new cryptographic algorithms, such updates or algorithms can be seamlessly integrated by extending the sequencer to handle additional operations. This flexibility ensures that the instruction-set PQC engine 115 remains robust and future-proof.

The following table lists different operations used in the high-level hardware controller 120.

### Keccak and Samplers Opcodes:

| Instruction | Description |
|---|---|
| RST_Keccak | Reset the Keccak SIPO buffer |
| EN_Keccak | Enable the Keccak |
| LDKeccak_MEM src, len | Load Keccak SIPO buffer at memory address |
| | src in len -width |
| LDKeccak_REG src, len | Load Keccak SIPO buffer at register |
| | ID src in len -width |
| RDKeccak_MEM dest, len | Read Keccak PISO buffer and store it at |
| | memory address dest in len -width |
| RDKeccak_REG dest, len | Read Keccak PISO buffer and store it at |
| | register ID dest in len -width |
| REJBOUND_SMPL dest | Start Keccak and RejBounded sampler and |
| | store the results at memory address dest |
| REJ_SMPL | Start Keccak and rejection sampler (results is |
| | used by PWM) |
| SMPL_INBALL | Start Keccak and SampleInBall (results is |
| | stored in SampleInBall memory) |
| EXP_MASK dest | Start Keccak and ExpandMask sampler and |
| | store the results at memory address dest |

### NTT/INTT/PWO Opcodes:

| Instruction | Description |
|---|---|
| NTT src, temp, dest | Perform NTT on data at memory address src |
| | and store the results at address dest |
| INTT src, temp, dest | Perform INTT on data at memory address src |
| | and store the results at address dest |
| PWM src0, src1, dest | Perform PWM on data at memory address |
| | src0 and src1 and store the results at address |
| | dest (dest = src0*src1) |
| PWM_SMPL src, dest | Perform PWM on data from sampler and at |
| | memory address src and store the results at |
| | address dest (dest = smpl*src) |
| PWM_ACCU src0, src1, | Perform PWM in accumulation mode on data |
| dest | at memory address src0 and src1 and store the |
| | results at address dest (dest = src0*src1 + dest) |
| PWM_ACCU_SMPL | Perform PWM in accumulation mode on data |
| src, dest | from sampler and at memory address src and |
| | store the results at address dest (dest = |
| | smpl*src + dest) |
| PWA src0, src1, dest | Perform PWA on data at memory address src0 |
| | and src1 and store the results at address dest |
| | (dest = src0 + src1) |
| PWS src0, src1, dest | Perform PWS on data at memory src0 and |
| | src1 and store the results at address dest |
| | (dest = src0 − src1) |

### Other Opcodes:

| Instruction | Description |
|---|---|
| MAKEHINT src, dest | Perform MakeHint on data at memory |
| | address src and store the results at register |
| | API address dest |
| USEHINT src0, src1 | Perform Decompose on w data at memory |
| | address src0 considering the hint data at |
| | memory address src1, and perform |
| | W1Encode on w1 and store them into |
| | Keccak SIPO |
| NORM_CHK src, mode | Perform NormCheck on data at memory |
| | address src with mode configuration |
| SIG_ENCODE src0, src1, | Perform sigEncode on data at memory |
| dest | address src0 and src1 and store the results |
| | at register API address dest |
| DECOMP_SIGN src, dest | Perform Decompose on w data at memory |
| | address src and store w0 at memory |
| | address dest, and perform W1Encode on |
| | w1 and store them into Keccak SIPO |
| UPDATE κ | The value of κ will be updated as κ + l |
| POWER2ROUND src, | Perform Power2Round on t data at memory |
| dest0, dest1 | address src and store t0 at register API |
| | address dest0 and t1 at register API |
| | address dest1 |
| SIG_DECODE_Z src, | Perform sigDecode_z on data at register |
| dest | API address src and store the results at |
| | memory address dest |
| SIG_DECODE_H src, | Perform sigDecode_h on data at register |
| dest | API address src and store the results at |
| | memory address dest |

As an example, the required instructions for performing verifying operation is described as follows:

The algorithm, Algorithm 3 in the current NIST standard, for verifying is presented below. Specifics of each operation are described in the following Paragraphs. The operations and instructions utilize one or more of the hardware units 130.

ALGORITHM 3
ML-DSA.Verify(pk, M, σ)

Verifies a signature σ for a message M.
Input: Public key, pk ϵ [symbol] and message M ϵ {0, 1}*.
Input: Signature, σ ϵ [symbol] .
Output: Boolean

| 1: | (ρ, tₗ) ← pkDecode(pk) | |
|---|---|---|
| 2: | (\tilde{c}, z, h) < sigDecode(σ) | [symbol] Signer's commitment hash \tilde{c}, response z and hint h |
| 3: | if h = ⊥ then return false | [symbol] Hint was not properly encoded |
| 4: | end if | |
| 5: | Â ← ExpandA(ρ) | [symbol] A is generated and stored in NTT representation as Â |
| 6: | tr ← H(BytesToBits(pk), 512) | |
| 7: | μ ← H(tr\|\|M, 512) | [symbol] Compute message representative μ |
| 8: | (\tilde{c}₁, \tilde{c}₂) ϵ {0, 1}²⁵⁶ × {0, 1}^{2λ-256} ← \tilde{c} | |
| 9: | c ← SampleInBall(\tilde{c}₁) | [symbol] Compute verifier's challenge from \tilde{c} |
| 10: | w′_{Approx} ← { NTT⁻¹ (Â ○ NTT(z) − NTT (c) ○ NTT₁ • 2^{d})) | [symbol] w′_{Approx} = Az − ct₁ • 2^{d} |
| 11: | w′₁ ← UseHint (h, w′_{Approx}) | [symbol] Reconstruction of signer's commitment |
| 12: | \tilde{c}¹ ← H(μ\|\|w1Encode(w′₁), 2λ) | [symbol] Hash it; this should match \tilde{c} |

| | |
|---|---|
| 13: | return [[ \|\|z\|\|_{∞} < γ₁ − β]] and [[\tilde{c} = \tilde{c}′] and [[number of l's in h is ≤ ω]] |

$$( ρ , t 1 ) ← pkDecode ( pk )$$

pkDecode is called to decode the given pk for t1 values.

| | | | | |
|---|---|---|---|---|
| Operation | Opcode | operand | operand | operand |

| | | | |
|---|---|---|---|
| t1←pkDecode(pk) | pkDecode | pk | t1 |

(c^{˜},z,h)←sigDecode(σ)

sigDecode is called to decode the given signature for z and h values.

| | | | | |
|---|---|---|---|---|
| Operation | Opcode | operand | operand | operand |

| | | | |
|---|---|---|---|
| (z, h)←sigDecode(σ) | sigDecode_z | σ_z | z |
| | sigDecode_h | σ_h | h |

$$‖ z ‖ ∞ \geq γ 1 - β$$

Norm_Check is called to perform validity check on the given z. The output will be stored as an individual flag in the high-level architecture.

| | | | | |
|---|---|---|---|---|
| Operation | Opcode | operand | operand | operand |

| | | | |
|---|---|---|---|
| Valid = NormCheck(z) | NormChk | z | mode |

[[number of 1's in his≤ω]]

HintSum is called to perform validity check on the given h. The output will be stored as an individual flag in the high-level architecture.

| | | | | |
|---|---|---|---|---|
| Operation | Opcode | Operand | operand | operand |

| | | |
|---|---|---|
| Valid = HintSum(h) | HINTSUM | H |

z←NTT(z)

NTT is called for z by passing three addresses. Temp address can be the same for all NTT calls while init and destination are different.

| Operation | opcode | operand | operand | operand |
|---|---|---|---|---|
| NTT(z) | NTT | z_0 | temp | z_0_ntt |
| | NTT | z_1 | temp | z_1_ntt |
| | . . . | | | |
| | NTT | z_6 | temp | z_6_ntt |

A\hat{ }←ExpandA(ρ) AND A\hat{ }∘NTT(z)

Rejection sampling and PWM are performed simultaneously. Rejection sampling takes p from the register map 220 API and appends two bytes of Keccak SIPO to the end of the given p and then starts padding from there. The rejection sampler is run 56 times with shake128 mode, where k*l=56.

Each polynomial requires p and the necessary constants to fill SIPO. Then Rejection_sample opcode activates both Keccak and sampler. The output of rejection sampler goes straight to PWM unit. Then, the pwm opcode turns on pwm core, which can check the input from rejection sampler for a valid input.

There are two different opcodes for PWM: regular PWM and PWM_ACCU that indicates different modes for PWM units.

To mask the latency of SIPO, the Keccak_SIPO can be invoked when PWM/Rejection_sampler is handling the previous data. However, the Keccak will not be enabled until PWM is done.

| Operation | Opcode | operand | operand | operand |
|---|---|---|---|---|
| Az_0 = PWM(A, | Keccak_SIPO | p | 0 (1 byte) | 0 (1 byte) |
| NTT(z)) | | | | |
| | Rejection_sampler | | | |
| | Pwm | DONTCARE | z_0_ntt | Az0 |
| | Keccak_SIPO | p | 0 | 1 |
| | Rejection_sampler | | | |
| | pwm_accu | DONTCARE | z_1_ntt | Az0 |
| | Keccak_SIPO | p | 0 | 2 |
| | Rejection_sampler | | | |
| | pwm_accu | DONTCARE | z_2_ntt | Az0 |
| | . . . | | | |
| | Keccak_SIPO | p | 0 | 6 |
| | Rejection_sampler | | | |
| | pwm_accu | DONTCARE | z_6_ntt | Az0 |
| Az_1 = PWM(A, | Keccak_SIPO | p | 1 | 0 |
| NTT(z)) | | | | |
| | Rejection_sampler | | | |
| | Pwm | DONTCARE | z_0_ntt | Az1 |
| | Keccak_SIPO | p | 1 | 1 |
| | Rejection_sampler | | | |
| | pwm_accu | DONTCARE | z_1_ntt | Az1 |
| | . . . | | | |
| | Keccak_SIPO | p | 1 | 6 |
| | Rejection_sampler | | | |
| | pwm_accu | DONTCARE | z_6_ntt | Az1 |
| Az_7 = PWM(A, | . . . | | | |
| NTT(z)) | | | | |
| | Keccak_SIPO | p | 7 | 6 |
| | Rejection_sampler | | | |
| | pwm_accu | DONTCARE | z_6_ntt | Az7 |

tr←H(pk,512)

The sequencer runs Keccak operation on pk. pk is stored in register API as input, and we need to perform SHAKE256 with to generate 512 bits output.

| Operation | opcode | operand | operand | operand |
|---|---|---|---|---|
| tr = Keccak(pk) | Keccak_SIPO | pk | 2592 bytes | |
| | Keccak_PISO | tr | 64 bytes | |

μ←H(tr∥M,512)

The sequencer starts with running Keccak operation on tr and the given message. tr is stored in an internal register from the previous step, and the message is stored in register API as input, and we need to perform SHAKE256 with to generate 512 bits output.

| | | | | |
|---|---|---|---|---|
| Operation | opcode | operand | operand | operand |

| | | | |
|---|---|---|---|
| μ = Keccak(tr \|\| M) | Keccak_SIPO | tr | 64 bytes |
| | Keccak_SIPO | Message | 64 bytes |
| | Keccak_PISO | μ | 64 bytes |

To being, a Keccak input buffer is filled with tr and then concatenated with message. NIST may apply some changes in this operation by adding some constant value into this concatenation. Then a Keccak core can be run. The Keccak output stored in PISO is used to set the μ value into a special register.
c←SampleInBall(c^{˜}1)

The cl values are taken from register API as the Keccak input and SampleInBall is run. The output stays in the SampleInBall memory.

| | | | | |
|---|---|---|---|---|
| Operation | Opcode | operand | operand | operand |

| | | | |
|---|---|---|---|
| | Keccak_SIPO | c1 | 64 bytes |
| c ←SampleInBall(c^{~}1) | SMPL_INBALL | | |

c\hat{ }←NTT(c)

NTT is called for c by passing three addresses. Temp address can be the same for all NTT calls while init and destination are different.

| Operation | Opcode | operand | operand | operand |
|---|---|---|---|---|
| NTT(c) | NTT | c | temp | c_ntt |

c\hat{ }←NTT(c)

NTT is called for c by passing three addresses. Temp address can be the same for all NTT calls while init and destination are different.

| Operation | opcode | operand | operand | operand |
|---|---|---|---|---|
| NTT(c) | NTT | c | temp | c_ntt |

t1←NTT(t1)

NTT is called for t1 by passing three addresses. Temp address can be the same for all NTT calls while init and destination are different.

| Operation | opcode | operand | operand | operand |
|---|---|---|---|---|
| NTT(t1) | NTT | t1_0 | temp | t1_0_ntt |
| | NTT | t1_1 | temp | t1_1_ntt |
| | . . . | | | |
| | NTT | t1_7 | temp | t1_7_ntt |

NTT(c)∘NTT(t1)

Point-wise multiplication between c and all t1 polynomials in NTT domain is called.

| Operation | opcode | operand | operand | operand |
|---|---|---|---|---|
| ct1 = | PWM | c_ntt | t1_0_ntt | ct1_0 |
| PWM(NTT(c) ° NTT(t1)) | | | | |
| | PWM | c_ntt | t1_1_ntt | ct1_1 |
| | . . . | | | |
| . | PWM | c_ntt | t1_7_ntt | ct1_7 |

A\hat{ }∘NTT(z)−NTT(c)∘NTT(t1)

Point-wise subtraction between Az and ct1 polynomials in NTT domain is called.

| Operation | opcode | operand | operand | operand |
|---|---|---|---|---|
| Az − ct1 = A \hat{ } ° NTT(z) − | PWS | Az_0 | ct1_0 | Az_ct1_0 |
| NTT(c) ° NTT(t1) | | | | |
| | PWS | Az_1 | ct1_1 | Az_ct1_1 |
| | . . . | | | |
| . | PWS | Az_7 | ct1_7 | Az_ct1_7 |

w′←NTT−1(A\hat{ }∘NTT(z)−NTT(c)∘NTT(t1))

INTT for Az_ct1 is called by passing three addresses. Temp address can be the same for all INTT calls while init and destination are different.

| Operation | Opcode | operand | operand | operand |
|---|---|---|---|---|
| w′ ←NTT-1(A \hat{ } ° NTT(z) − | INTT | Az_ct1_0 | temp | w′_0 |
| NTT(c) ° NTT(t1)) | | | | |
| | INTT | Az_ct1_1 | temp | w′_1 |
| | . . . | | | |
| | INTT | Az_ct1_7 | temp | w′_7 |

w′←UseHint(h,w′) AND c^{˜}←H(μ∥w1Encode(w1),2λ)

In the UseHint phase, the decompose unit retrieves w from memory and divides it into two components. Next, w1 is refreshed through useHint, encoded, and forwarded to the Keccak SIPO. Nonetheless, the μ prefix must precede w1 before SIPO can accept it. Therefore, the high-level controller should provide μ before using decompose. After completing the UseHint operation, the high-level controller needs to add the necessary padding for H(μ∥w1Encode(w1),2λ). Then, the Keccak will start and the data in the SIPO will be stored at register API as verification result.

| | | | | |
|---|---|---|---|---|
| Operation | Opcode | operand | operand | operand |

| | | | |
|---|---|---|---|
| H(μ\|\|w1Encode(w1), 2λ) | LDKeccak | M | 64 bytes |
| w′ ←UseHint(h, w′) | USEHINT | W | H |
| H(μ\|\|w1Encode(w1), 2λ) | LDKeccak | padding | |
| | EN_Keccak | | |
| | RDKeccak | Verification | |
| | | Result | |

Algorithm 1 in the NIST standard is for key generation and also utilizes the hardware elements:

ALGORITHM 1
ML-DSA. KeyGen( )

Generates a private-private key pair.
Ouput: Public key, pk ϵ [symbol] .
and private key, sk ϵ [symbol] .

| | | |
|---|---|---|
| 1: | ζ ← {0, 1}²⁵⁶ | [symbol] Choose random seed |
| 2: | (ρ, ρ′, k) ϵ {0, 1}²⁵⁶ × {0, 1)⁵¹² × {0, 1}²⁵⁶ ← H(ζ, 1024) | [symbol] Expand seed |
| 3: | Â ← ExpandÂ(ρ) | [symbol] A is generated nad stored in NTT represent as Â |
| 4: | (s₁, s₂) ← ExpandS(ρ′) | |
| 5: | t ← NTT⁻¹ (Â ○ NTT (s₁)) + s₂ | [symbol] Compute t = As₁ + s₂ |
| 6: | (t₁, t₀) ← Power2Round(t,d) | [symbol] Compress 1 |
| 7: | pk ← pkEncode(ρ, t₁) | |
| 8: | tr ← H(BytesToBits(pk), 512) | |
| 9: | sk ← H skEncode(ρ, K, rr, s₁, s₂, t₀) | [symbol] K and rr are for use in signing |
| 10: | return (pk, sk) | |

Algorithm 2 in the NIST standard is for signature generation of a message M:

ALGORITHM 2
ML-DSA Sign(sk, M)

Generates a signature for a message M.
Input: Private key, sk ϵ [symbol] and the message M ϵ {0, 1} [symbol] .
Output: Signature, σ ϵ [symbol] .

| 1: | (ρ, K, tr, s₁, s₂, t₀) ← skDecode(sk) | |
|---|---|---|
| 2: | s₁ ← NTT (s₁) | |
| 3: | s₂ ← NTT (s₂) | |
| 4: | t₀ ← NTT(t₀) | |
| 5: | Â ← ExpandÂ(ρ) | [symbol] A is generated and stored iss NTT representation as Â |
| 6: | μ ← H(tr\|\|M, 512) | [symbol] Compute message representative μ |
| 7: | end ← (0, 1)²⁵⁶ | [symbol] For the optional deterministic variant, substitute rnd ← {0}²⁵⁶ |
| 8: | ρ′ ← H(K\|\|rnd\|\|μ, 512) | [symbol] Compute private randoms seed |
| 9: | κ ← 0 | [symbol] Initialize counter κ |
| 10: | (z, h) ← ⊥ | |
| 11: | while (z, h) = ⊥ do | [symbol] Rejection sampling loop |
| 12: | y ← ExpandMask(ρ′, κ) | |
| 13: | w ← NTT⁻¹ (Â ○ NTT (y)) | |
| 14: | w₁ ← HighBits(w) | [symbol] Signer's commitment |
| 15: | \tilde{c} ϵ {0, 1}^{2λ} ← H(μ\|\|w1Encode(w₁), 2λ) | [symbol] Commitment hash |
| 16: | (\tilde{c}_{1,} (\tilde{c}₂) ϵ {0, 1}²⁵⁶ × {0, 1}^{2λ - 256} ← \tilde{c} | [symbol] First 256 bits of commitment bash |
| 17: | [symbol] ← SampleInBall (\tilde{c}₁) | [symbol] Verifier's challenge |
| 18: | \tilde{c} ← NTT (c) | |
| 19: | ((cs₁)) ← NTT⁻¹ (\tilde{c} ○ \tilde{s}₁) | |
| 20: | ((cs₂)) ← NTT⁻¹ (\tilde{c} ○ \tilde{s}₂) | |
| 21: | z ← y + ((cs₁) | [symbol] Signer's response |
| 22: | r₀ ← LowBits(w − ((cs₂))) | |
| 23: | If \|\|z\|\|_{∞} ≥ γ₁ − β or \|\|r₀\|\|_{∞} ≥ γ₂ − β then (z, h) ← ⊥ | [symbol] Validity checks |
| 24: | else | |
| 25: | ((ct₀)) ← NTT⁻¹ (\tilde{c} ○ t₀) | |
| 26: | h ← MakeHint(−((ct₀)), w − ((cs₂)) + ((ct₀))) | [symbol] Signer's hint |
| 27: | if \|\|(( [symbol] t₀))_{∞} ≥ γ₂ or the number is [symbol] in h is greater than ω, then (z,h) ← ⊥ | |
| 28: | end if | |
| 29: | end if | |
| 30: | κ ← κ + l | [symbol] Increment counter |
| 31: | end while | |
| 32: | σ ← SigEncode (\tilde{c},z mod [symbol] q,h) | |
| 33: | return σ | |

[symbol]

indicates data missing or illegible when filed

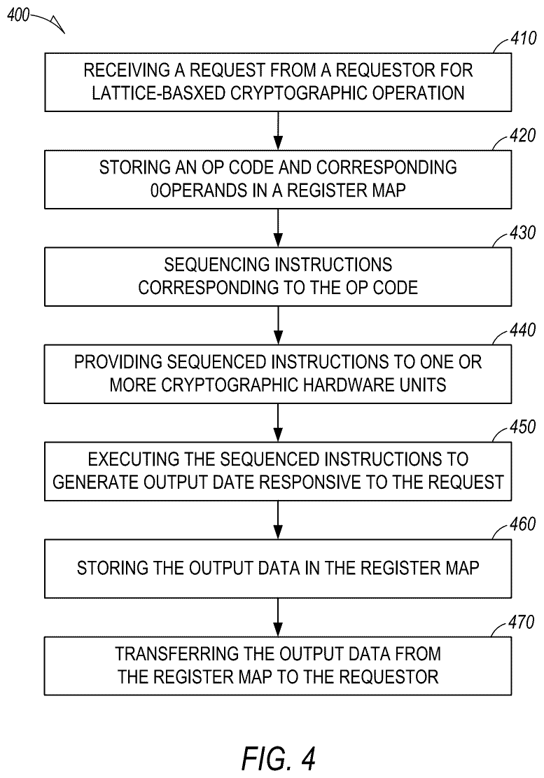

FIG. 4 is a flowchart illustrating a method 400 of performing lattice-based cryptographic operations via a hardware engine that includes programmable instructions sets corresponding to the operations. Method 400 begins at operation 410 by receiving a request from a requestor for a lattice-based cryptographic operation via an application programming interface of a hardware cryptographic engine. At operation 420, an opcode and corresponding operands are stored in a register map of the engine. Instructions corresponding to the opcode are sequenced at operation 430. Operation 440 provides sequenced instructions to one or more cryptographic hardware units of the engine. The sequenced instructions are executed at operation 450 to generate output data responsive to the request. Operation 460 stores the output data in the register map. The output data is transferred at operation 470 from the register map to the requestor.

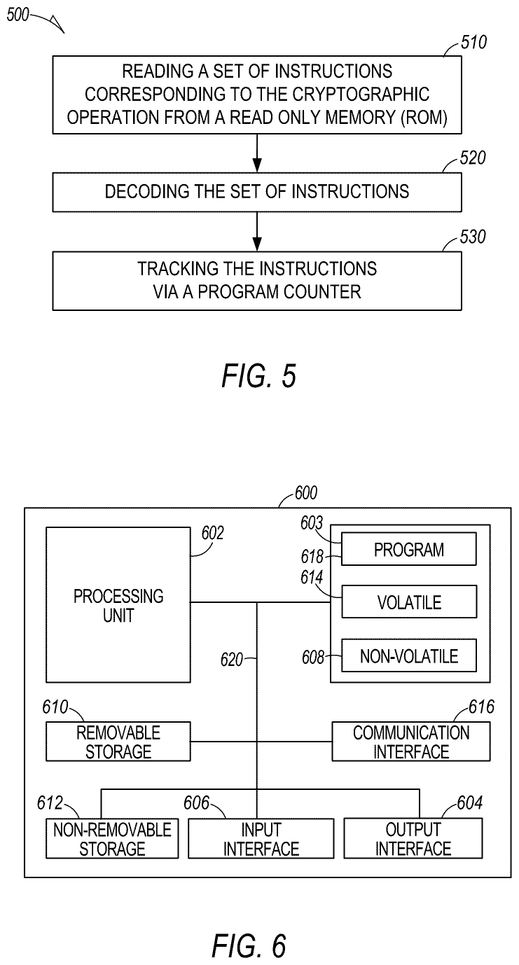

FIG. 5 is a flowchart illustrating a method 500 of sequencing instructions. Method 500 sequences instructions by reading a set of instructions corresponding to the cryptographic operation at operation 510 from a read only memory (ROM). The set of instructions are decoded at operation 520. The sequence of instructions are tracked at operation 530 via a program counter.

FIG. 6 is a block schematic diagram of a computer system 600 to implement controller 120 as a hardware controller and for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment. In the system 100, computer system 600 takes the form of a hardware based controller, such as a Adam's bridge accelerator or controller.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 618 along with the workspace manager 622 may be used to cause processing unit 602 to perform one or more methods or algorithms described herein.

### Examples

1. A computer implemented method includes receiving a request, including operands, from a requestor for a lattice-based cryptographic operation via an application programming interface of a hardware cryptographic engine, storing the operands in a register map of the engine, sequencing instructions corresponding to the request, providing sequenced instructions to one or more cryptographic hardware units of the engine, executing the sequenced instructions to generate output data responsive to the request, storing the output data in the register map, and transferring the output data from the register map to the requestor.

2. The method of example 1 wherein sequencing instructions includes reading a set of instructions corresponding to the cryptographic operation from a read only memory (ROM) and decoding the set of instructions.

3. The method of example 2 wherein sequencing instructions further includes tracking the instructions via a program counter.

4. The method of any of examples 2-3 wherein the ROM includes sets of instructions, each set corresponding to different cryptographic operations.

5. The method of example 4 wherein the different cryptographic operations include key generation, signature generation, and signature verification.

6. The method of any of examples 1-5 wherein the instructions are executed by at least one of hardware sampler units, a hardware NTT unit, and hardware auxiliary units.

7. The method of example 6 wherein the hardware sampler units include a rejection sampler unit, a rejection bounded sampler unit, and sample InBall unit.

8. The method of any of examples 6-7 wherein the hardware auxiliary units include a MakeHint unit, a UseHint unit, and a HintSum unit.

9. The method of any of examples 6-8 wherein the instructions are further executed by a hashing unit that includes a serial-in parallel-out (SIPO) memory, a Keccak unit, and a parallel-in serial-out (PISO) memory.

10. A lattice-based cryptography engine includes an interface configured to receive a lattice-based cryptographic operation request including corresponding operands. A register map is configured to store the operands and response to the request. A controller is coupled to receive the operands and output a sequence of instructions responsive to the request. A plurality of hardware units is coupled to receive and execute the instructions to generate the response. Each instruction is designated for one of the plurality of hardware units. A memory is coupled to the hardware units.

11. The lattice-based cryptography engine of example 10 wherein the controller includes a read only memory (ROM) storing the instructions, a sequencer coupled to the ROM, and an instruction decode coupled to the sequencer.

12. The lattice-based cryptography engine of example 11 and further including a program counter coupled to the sequencer.

13. The lattice-based cryptography engine of any of examples 11-12 wherein the ROM includes sets of instructions, each set corresponding to different cryptographic operations.

14. The lattice-based cryptography engine of example 13 wherein the cryptographic operations include key generation, signature generation, and signature verification.

15. The lattice-based cryptography engine of any of examples 10-14 wherein the hardware units include sampler units, NTT units, and auxiliary units.

16. The lattice-based cryptography engine of example 15 wherein the sampler units include a rejection sampler unit, a rejection bounded sampler unit, and sample InBall unit.

17. The lattice-based cryptography engine of any of examples 15-16 wherein the auxiliary units include a MakeHint unit, a UseHint unit, and a HintSum unit.

18. The lattice-based cryptography engine of example 17 wherein the auxiliary units further include a Pack unit, and Unpack unit, an Encode unit, a Decode unit, a Comp unit, a Decomp unit, and a Ck Norm unit.

19. The lattice-based cryptography engine of any of examples 15-18 and further including hashing units, a serial-in parallel-out memory, a Keccak unit, and a parallel-in serial-out memory.

20. A lattice-based cryptography engine includes an interface configured to receive a lattice-based cryptographic operation request including corresponding operands, a register map configured to store the operands and a response to a request identifying a cryptographic operation, a controller coupled to receive the operands and output a sequence of instructions responsive to the request, and a plurality of hardware units coupled to receive and execute the instructions to generate the response, each instruction designated for one of the plurality of hardware units.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a request, including operands, from a requestor for a lattice-based cryptographic operation via an application programming interface of a hardware cryptographic engine;
storing the operands in a register map of the engine;
sequencing instructions corresponding to the request;
providing sequenced instructions to one or more cryptographic hardware units of the engine;
executing the sequenced instructions to generate output data responsive to the request;
storing the output data in the register map; and
transferring the output data from the register map to the requestor.

2. The method of claim 1 wherein sequencing instructions comprises:
reading a set of instructions corresponding to the cryptographic operation from a read only memory (ROM); and
decoding the set of instructions.

3. The method of claim 2 wherein sequencing instructions further comprises tracking the instructions via a program counter.

4. The method of claim 2 wherein the ROM includes sets of instructions, each set corresponding to different cryptographic operations.

5. The method of claim 4 wherein the different cryptographic operations include key generation, signature generation, and signature verification.

6. The method of claim 1 wherein the instructions are executed by at least one of hardware sampler units, a hardware NTT unit, and hardware auxiliary units.

7. The method of claim 6 wherein the hardware sampler units include a rejection sampler unit, a rejection bounded sampler unit, and sample InBall unit.

8. The method of claim 6 wherein the hardware auxiliary units include a MakeHint unit, a UseHint unit, and a HintSum unit.

9. The method of claim 6 wherein the instructions are further executed by a hashing unit that includes a serial-in parallel-out (SIPO) memory, a Keccak unit, and a parallel-in serial-out (PISO) memory.

10. A lattice-based cryptography engine comprising:
an interface configured to receive a lattice-based cryptographic operation request including corresponding operands;
a register map configured to store the operands and response to the request;
a controller coupled to receive the operands and output a sequence of instructions responsive to the request;
a plurality of hardware units coupled to receive and execute the instructions to generate the response, each instruction designated for one of the plurality of hardware units; and
a memory coupled to the hardware units.

11. The lattice-based cryptography engine of claim 10 wherein the controller comprises:
a read only memory (ROM) storing the instructions;
a sequencer coupled to the ROM; and
an instruction decode coupled to the sequencer.

12. The lattice-based cryptography engine of claim 11 and further comprising a program counter coupled to the sequencer.

13. The lattice-based cryptography engine of claim 11 wherein the ROM includes sets of instructions, each set corresponding to different cryptographic operations.

14. The lattice-based cryptography engine of claim 13 wherein the cryptographic operations include key generation, signature generation, and signature verification.

15. The lattice-based cryptography engine of claim 10 wherein the hardware units comprise sampler units, NTT units, and auxiliary units.

16. The lattice-based cryptography engine of claim 15 wherein the sampler units include a rejection sampler unit, a rejection bounded sampler unit, and sample InBall unit.

17. The lattice-based cryptography engine of claim 15 wherein the auxiliary units include a MakeHint unit, a UseHint unit, and a HintSum unit.

18. The lattice-based cryptography engine of claim 17 wherein the auxiliary units further include a Pack unit, and Unpack unit, an Encode unit, a Decode unit, a Comp unit, a Decomp unit, and a Ck Norm unit.

19. The lattice-based cryptography engine of claim 15 and further including hashing units, a serial-in parallel-out memory, a Keccak unit, and a parallel-in serial-out memory.

20. A lattice-based cryptography engine comprising:
an interface configured to receive a lattice-based cryptographic operation request including corresponding operands;
a register map configured to store the operands and a response to a request identifying a cryptographic operation;
a controller coupled to receive the operands and output a sequence of instructions responsive to the request; and
a plurality of hardware units coupled to receive and execute the instructions to generate the response, each instruction designated for one of the plurality of hardware units.
